(19) United States
(12) Patent Application Publication
(10) Pub. No.: US 2014/0012655 A1
(43) Pub. Date: Jan. 9, 2014

(54) SYSTEM AND METHOD FOR PURCHASING WITH A DISCOUNT IN EXCHANGE FOR SOCIAL MEDIA ADVERTISING

(71) Applicants: Ami POLAK, Patah Tikva (IL); Gilad Waksman, Tel-Aviv (IL); Jonathan Shpigel, Tel-Aviv (IL); Michael Bar-Zeev, Tel-Aviv (IL)

(72) Inventors: Ami POLAK, Patah Tikva (IL); Gilad Waksman, Tel-Aviv (IL); Jonathan Shpigel, Tel-Aviv (IL); Michael Bar-Zeev, Tel-Aviv (IL)

(73) Assignee: SHOP CLOUD LTD, Petah Tikva (IL)

(21) Appl. No.: 13/541,776

(22) Filed: Jul. 5, 2012

(51) Int. Cl. G06Q 30/02

(52) U.S. Cl. 705/14.39

(57) ABSTRACT

A method of receiving discounts in exchange for social media advertising for items in a store, including, finding an item of interest at a store by a customer with a mobile device that is configured to execute a discount application; wherein an item code is displayed on or near the item; entering the item code into the mobile device; communicating the item code to a remote server computer to retrieve information about the item; retrieving the information about the item from the server, wherein the information includes one or more discount options that are provided responsive to publication of the item in a social network in which the customer participates; storing the information about the item and the discount options in a list that is accessible by the mobile device.

### TECHNICAL FIELD

The present disclosure relates generally to a system and method of providing discounts to customers in exchange for social media advertising and more specifically using mobile devices at the premise of a business to receive the discount and publicize the item.

### BACKGROUND

Generally in modern stores many potential customers browse available products but only a small percent of the browsing actually results in sales. It is estimated that in some businesses 90% of the people browse products and leave without purchasing. Some of the reasons for unrealized sales are lack of information about the product when standing in front of it, or dissatisfaction with the price. In contrast when purchasing online you can search for information about the product but you lack the experience of seeing the product live.

In stores the retailer needs to invest in sales people to provide information to the customers; however many customers are intimidated by salespeople that ask them if they need help, especially when they are only beginning to look. Additionally, most modern stores have fixed prices and it is not accepted for customers to haggle over the price at the check out especially when other customers are waiting on line.

As a result retailers generally receive little feedback regarding unfulfilled consumer interest in their products. Most potential customers simply leave without notifying the retailer that they are interested in a product but need more information, would like a reduction or would purchase the item at a specific price. Accordingly, the retailer has no way of knowing if a specific price for a product might be translated into enhanced sales, or if the potential customers might be interested in similar products in a different price range. Likewise, the retailer generally has no way to contact potential customers after they walk away.

Many businesses also offer discount coupons as an incentive to attract customers to purchase at the premise of their business or to purchase their products at other stores. Generally the coupons are distributed with other products or in newspapers and magazines. The coupons serve as publicity for the business, their products and provide an incentive for customers to arrive at the premise of the business and purchase specific products.

Consumers may visit businesses, view their products and refrain from purchasing them due to the price or since they expect that they can acquire a coupon and purchase the item later with a discount.

In recent years the use of electronic coupons has been introduced. Some coupons can be obtained by accessing a web site and registering to receive a reduction at a store or by printing out a coupon. This method generally requires that the user search for coupons and plan purchases before arriving at the store. This method will prevent spontaneous purchases with a discount at a store. Also the retailer only benefits from the initial publication and not from the actual transaction.

In other methods the retailer sends emails or text messages to potential customers regarding various products. This method requires that the retailer obtain large lists of potential customers and is generally referred to as spam, since most of the recipients are not interested in receiving the emails or purchasing the products offered. Typically the response rate is low and a potential customer in a store may be unaware of such offers and not purchase an item, which the customer would have purchased if they had been aware of the offer. On the other hand just reducing the price for all customers in the store does not generally increase consumer awareness and draw in more potential customers.

### SUMMARY

An aspect of an embodiment of the disclosure relates to a system and method for a customer to receive discounts for an item at a store by publicizing the item in a social network of which the customer is a member. The method is performed by entering an item code that appears on or near the item to the mobile device. The item is then added to a wish list of the customer, so that the customer may view the details of the item and available discounts offered for the item with social network publicity requirements to obtain the discount. The customer may perform the social network publicity action and receive a discount code that can be redeemed upon checking out with the item. Optionally, the customer may order the item at a later date based on the details in the wish list.

In an exemplary embodiment of the disclosure, the item code is scanned into the mobile device using a scanning device such as a digital camera that is part of the device. Optionally, the item code is provided as a quick response (QR) code that appears on the package of the item or on a sign near the item. Alternatively or additionally, the item code can be entered manually by the customer (e.g. typing in an alphanumeric code). In some embodiments of the invention, the code may be provided by other means, for example using Bluetooth, RFID or NFC.

In an exemplary embodiment of the disclosure, the social network publicity requirements are per item, for example performing “like” to the item in the customer's Facebook account. Another example is posting the item on the wall of the customer's Facebook account so that the customer's friends will see the item or receive notification that the customer is interacting with the item (e.g. retrieving information about it or purchasing it). Alternatively or additionally, social network publicity requirements are per retailer, for example that the customer signs up to receive emails and/or other notifications from the retailer, or that the customer notifies friends linked to his/her social network that he/she is currently located at the retailer's store and interacting with items there. Optionally, different social network publicity requirements provide different discounts, for example dependent on the exposure size of the method or dependent on the number of links the customer has in his/her social network that are exposed to the publication action.

In an exemplary embodiment of the disclosure, the method also supports second tier customer interaction wherein friends of the customer may also add the item to their wish list and publicize it in their social network, for example performing “like” or posting it on their wall. Optionally, second tier customers may order the item and have it delivered without actually visiting the store.

In an exemplary embodiment of the disclosure, the device used by the customer in the store is a Smartphone or mobile telephone that communicates over a cellular network. Alternatively, the mobile device is a tablet computer, net-book computer laptop computer or similar device and it communicates over a wireless network with Internet access at the premise of the retailer or by having independent access to the Internet (e.g. over a cellular network).

There is thus provided according to an exemplary embodiment of the disclosure, a method of receiving a discount in exchange for social media advertising for items in a store, comprising:

Finding an item of interest at a store by a customer with a mobile device that is configured to execute a discount application; wherein an item code is displayed on or near the item;

Entering the item code into the mobile device;

Communicating the item code to a server computer to retrieve information about the item;

Retrieving the information about the item from the server, wherein the information includes one or more discount options that are provided responsive to publication of the item in a social network in which the customer participates;

Storing the information about the item and the discount options in a list that is accessible by the mobile device.

In an exemplary embodiment of the disclosure, the method further comprises:

Selecting a desired discount option;

Publicizing the item in the social network in which the customer participates;

Receiving a discount code from the server.

Optionally, the method further comprises:

Revealing the discount code when checking out at the store to receive a discount for the item.

In an exemplary embodiment of the disclosure, the method further comprises:

Offering customers at the checkout to generate a donation, where a specific sum or percent of the sale will be donated to a charitable cause by the retailer, responsive to publicizing the donation in the social network account of the customer;

Entering a donation code to initiate the donation.

Optionally, the method further comprises:

Ordering the item at any location or time based on the information in the list and providing the discount code.

In an exemplary embodiment of the disclosure, the method further comprises:

Viewing the publication of the item in the social network in which the customer participates by a friend of the customer using a computing device; and

Adding the item to a list at the friends computing device.

Optionally, the method further comprises:

Ordering the item by the friend from the list at the friends computing device.

In an exemplary embodiment of the disclosure, the method further comprises:

Notifying a store manager that one or more customers entered the item code of a specific item into their mobile device;

Updating the server to notify the one or more customers of a notification related to the item.

Optionally, entering the item code is performed by scanning the code with a digital camera of the device. In an exemplary embodiment of the disclosure, the item code is a quick response code. Optionally, the mobile device is a mobile telephone. In an exemplary embodiment of the disclosure, the mobile device is a Smartphone. Alternatively, the mobile device is a not a mobile telephone. In an exemplary embodiment of the disclosure, the list is stored at the server. Alternatively, the list is stored on the mobile device. In an exemplary embodiment of the disclosure, different types of publication provide discount options with different size discounts. Optionally, a publication with a larger exposure receives a larger discount. In an exemplary embodiment of the disclosure, the size of the discount is a function of the size of the customer's social network. Optionally, the mobile device communicates with the server over a wireless Internet network. Alternatively, the mobile device communicates with the server over a cellular wireless network.

There is further provided according to an exemplary embodiment of the disclosure, a system for receiving discounts for an item in a store, comprising:

A server computer for executing a discount application having a server handling component, a retailer handling component and a customer handling component;

Wherein the retailer component is configured to accept details of a retailer and details of items sold by the retailer at the store;

Wherein the customer handling component is configured to communicate with a mobile device used by the customer at the store and receive from the mobile device an item code that is displayed on or near the item in the store;

Wherein the server handling component is configured to provide the mobile device with information related to the item and one or more discount options that are provided responsive to publication of the item in a social network in which the customer participates.

In an exemplary embodiment of the disclosure, the customer handling component is configured to accept the selection of a discount option by the mobile device and generates or verifies publication of the item or the retailer in a social network in which the customer participates; and

Responsive to the verification, provide the mobile device with a discount code for the customer to receive a discount for the item when checking out at the store.

Optionally, the retailer handling component is configured to notify a retailer that one or more customers entered the item code of a specific item and receive from the retailer notifications related to the specific item; and transfer the notifications to one or more customers.

In an exemplary embodiment of the disclosure, the details of the items sold in the store include a description of the item, an item code, and one or more discount options that are provided responsive to publication of the item or the retailer in a social network in which the customer participates. Optionally, different types of publications provide the customer with different size discounts.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a system for purchasing with a discount in exchange for social media advertising, according to an exemplary embodiment of the disclosure;

FIG. 2 is a flow diagram of a method of purchasing with a discount in exchange for social media advertising, according to an exemplary embodiment of the disclosure;

FIG. 3 is a schematic illustration of a mobile device with a mobile discount application displaying a selected scanned item, according to an exemplary embodiment of the disclosure;

FIG. 4 is a schematic illustration of a mobile device with a discount application after receiving a discount message, according to an exemplary embodiment of the disclosure;

FIG. 5 is a schematic illustration of a mobile device with a discount application showing a customer wish list, according to an exemplary embodiment of the disclosure; and

FIG. 6 is a schematic illustration of a discount application, according to an exemplary embodiment of the disclosure.

### DETAILED DESCRIPTION

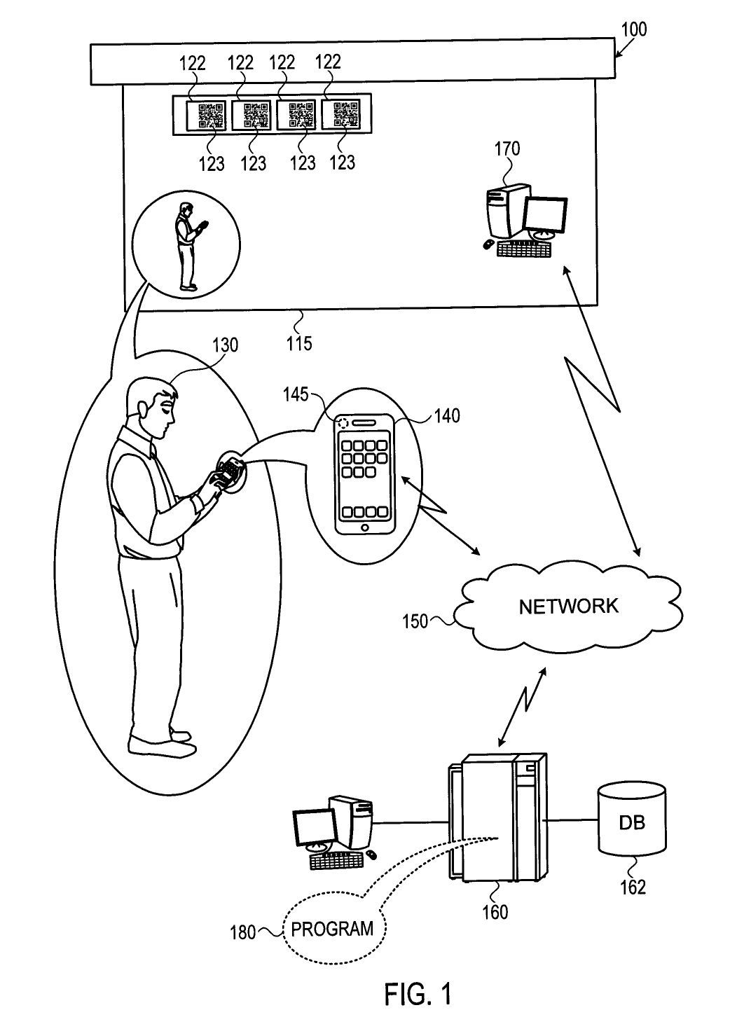

FIG. 1 is a schematic illustration of a system 100 for purchasing with a discount in exchange for social media advertising, according to an exemplary embodiment of the disclosure. Nowadays mobile devices such as mobile telephones have become commonplace personal appliances that are carried around by customers as they are shopping in stores. FIG. 1 shows a customer 130 carrying a mobile device 140 in a store 115. Optionally, the mobile device 140 includes an imaging device 145 such as a built-in digital camera. In an exemplary embodiment of the disclosure, the store offers various items 122 for sale. Optionally, each item is displayed with an item code 123 that identifies the item and wherein the code 123 can be scanned into the mobile device 140 by the imaging device 145. In an exemplary embodiment of the disclosure, the code 123 is a quick response (QR) code. Alternatively, code 123 may be a standard barcode or any type of alphanumeric code that can be scanned into the mobile device or typed in by the customer. In an exemplary embodiment of the disclosure customer 130 is offered a discount in purchasing the item in exchange for publicizing the item in a social network in which the customer 130 participates.

In an exemplary embodiment of the disclosure mobile device 140 is a mobile telephone, for example an iPhone or other type of Smartphone. Alternatively, the mobile device may be a laptop computer, a notebook computer, a tablet, a standard cellular telephone or other type of mobile device with a memory and processor capable of performing the application disclosed herein.

Optionally, mobile device 140 may use other input means such as an RFID reader, Bluetooth, a barcode reader, or other input devices to accept the item code 123 from item 122.

In an exemplary embodiment of the disclosure, mobile device 140 communicates over a network 150 with an application server 160. Network 150 may be a wireless cellular mobile network or a local wireless internet network. Optionally, Server 160 can be a general purpose computer with a memory and processor that executes a discount application 180. In an exemplary embodiment of the disclosure server 160 includes a database 162. Database 162 stores the lists and details of participating items, retailers, available discounts, transactions and other information needed for discount application 180 according to the disclosure below.

In an exemplary embodiment of the invention, a retailer uses a general purpose workstation 170 to access server 160 and provide item information, discount details and any other information required from the retailer. Optionally, retailer workstation 170 may be connected to server 160 over a wired or wireless connection (e.g. over the Internet), since retailer workstation 170 does not need to be mobile.

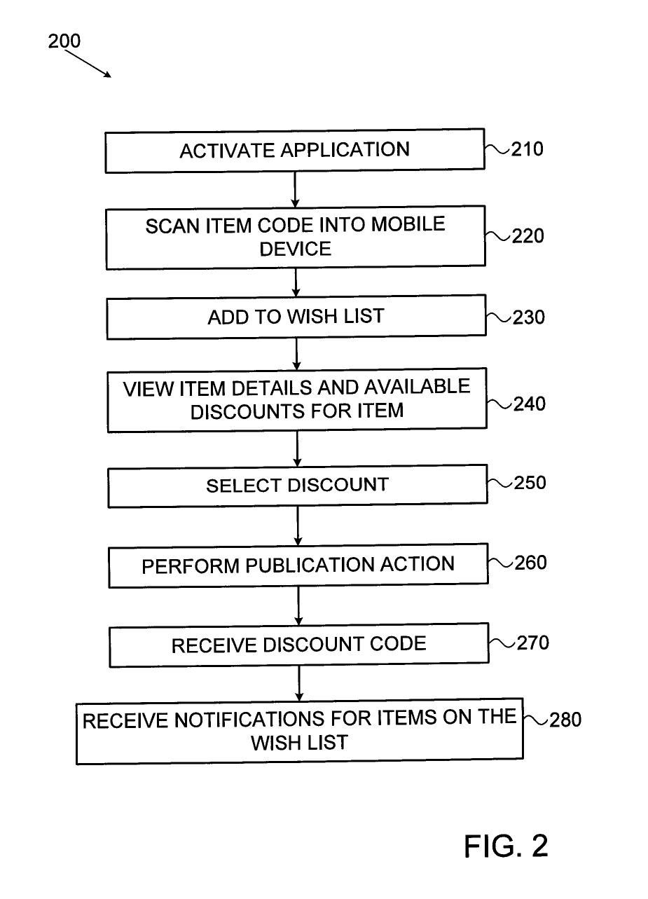

FIG. 2 is a flow diagram of a method 200 of purchasing with a discount in exchange for social media advertising, according to an exemplary embodiment of the disclosure. In an exemplary embodiment of the disclosure, the customer activates (210) discount application 180 on mobile device 140. Optionally, mobile device 140 receives discount application 180 by downloading it from server 160 or some other server. Alternatively, discount application 180 functions as a web application and is accessed from a web browser (e.g. Safari, Android browser) on mobile device 140 while interacting with server 160.

Optionally, discount application 180 allows the customer 130 to scan (220) the item code 123 that identifies items 122 and provides the customer 130 with the ability to act on the item 122. In an exemplary embodiment of the disclosure, the item details will be displayed on a display of mobile device 140. Optionally the details may include:

1. Retailer name/logo;

2. Item pictures (e.g. 0-9 pictures);

3. Item name;

4. Brand name;

5. Item price;

6. Item SKU (stock keeping unit);

7. Item variations (e.g. sizes, colors);

8. Item description;

9. General information about the item;

10. Comparison to similar items;

11. Links to additional information.

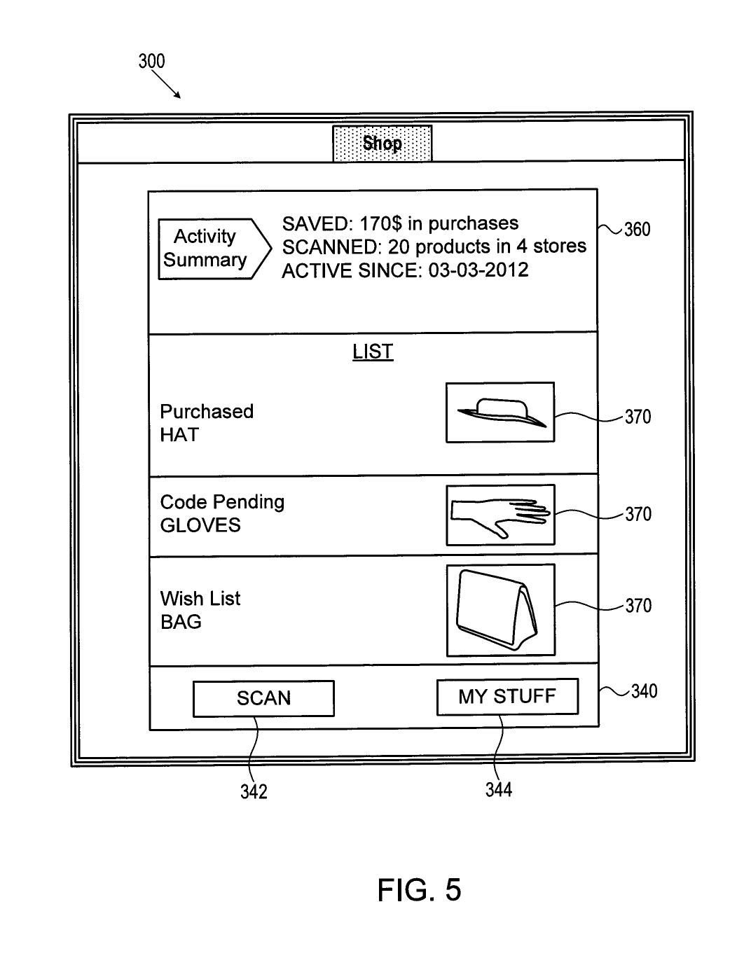

In some embodiments of the disclosure, mobile device 140 does not have an imaging device 145 and the customer 130 types in the item code 123. Alternatively, or additionally, the mobile device may use other inputs, such as Bluetooth, or an RFID reader. Once the item code 123 is entered the item is added (230) to a customer wish list 360 (shown in FIG. 5), which keeps track of items of interest to the customer.

In an exemplary embodiment of the disclosure, customer 130 can view (240) the details of any item in the wish list 360 and discounts that are available for the items. Optionally, customer 130 is provided with one or more discount options from which he/she may select (250). The discount options require that the customer publicize the item or the retailer (e.g. the name of the store/manufacturer) in a social network account of customer 130, for example in the customer's face book account or Tweeter account. Optionally, the discount is per item, for example by performing “like” for the item, or posting the item on the user's Face-book wall. Alternatively, or additionally, the discount is applied per store, for example by joining a retailer mailing list or by performing “check in” to the store, an action which notifies the customer's friends and followers that the customer 130 is located at the store 115. In an exemplary embodiment of the disclosure the discount application 180 automatically generates the publication for the customer 130 once the customer 130 selects a discount.

Activation of the discount process optionally requires that the customer 130 first login to his/her social network account and/or to discount application 180, select (250) the desired type of discount and perform (260) the required publication action to receive the discount or have it performed by the discount application 180. Alternatively, discount application 180 may automatically load the login screen for the customer's social network account so that the customer can login before continuing with the discount process.

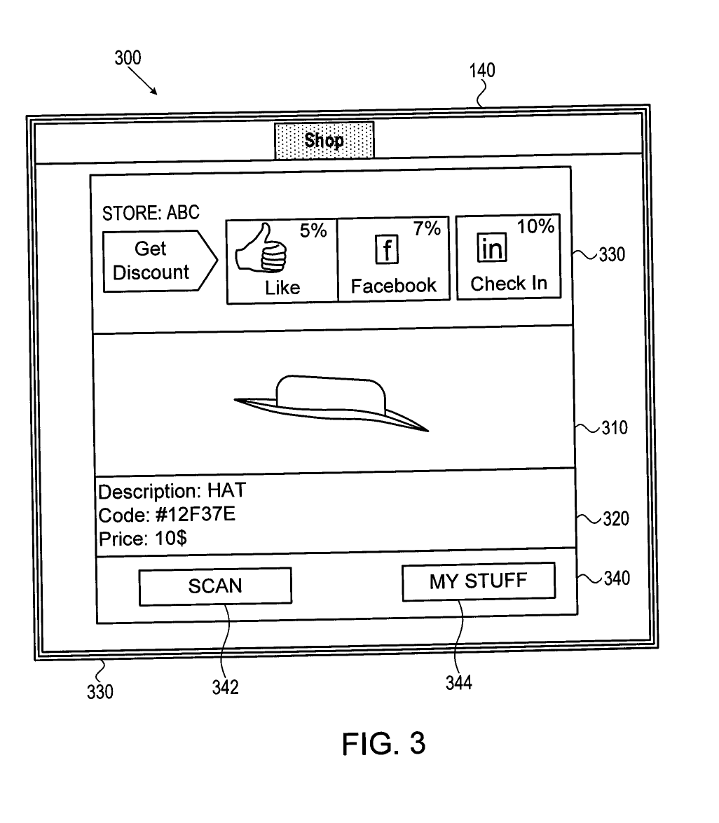

FIG. 3 is a schematic illustration of mobile device 140 displaying a mobile discount application 300 displaying a selected scanned item 122, according to an exemplary embodiment of the disclosure. In an exemplary embodiment of the disclosure, discount application 300 shows one or more pictures 310 of the item (e.g. 0-9 pictures and/or videos). Optionally, all the pictures may be shown simultaneously or the customer 130 may scroll through the pictures sequentially. Discount application 300 may also show a description 320 of the item including some or all of the details mentioned above. In an exemplary embodiment of the disclosure, discount application 300 displays an area 330 that lets the customer select the type of publication and a corresponding discount, for example if the customer performs a “like” for the item the customer 130 will receive a 5% discount, while if the customer shares the item on the wall of the customer's Facebook page, the customer 130 is awarded a 7% discount. Optionally, the discount may be higher if the publication is greater and lower if the publication is considered less exposing. In some embodiments of the disclosure the size of the discount may be a function of the number of links (e.g. friends/followers) the customer has in his/her social network. Alternatively or additionally, the discount may be increased if the customer has more than a pre-selected number of links.

In an exemplary embodiment of the disclosure, application 300 may include selection buttons (342 (scan), 344 (my stuff)) in a selection area 340 that allows the customer 130 to activate the scan process for an item 122 or to review the wish list 360 of the items that the customer 130 dealt with.

In an exemplary embodiment of the disclosure, after performing a publication the customer 130 receives (270) a message with the discount details. The message may include details such as a discount code value, a discount amount, a start date, expiry date and the item details. Optionally, the discount code will be added to the details of the item in the customer's wish list 360. The customer can then redeem the code by providing its value at the store check out or at a later date as explained below.

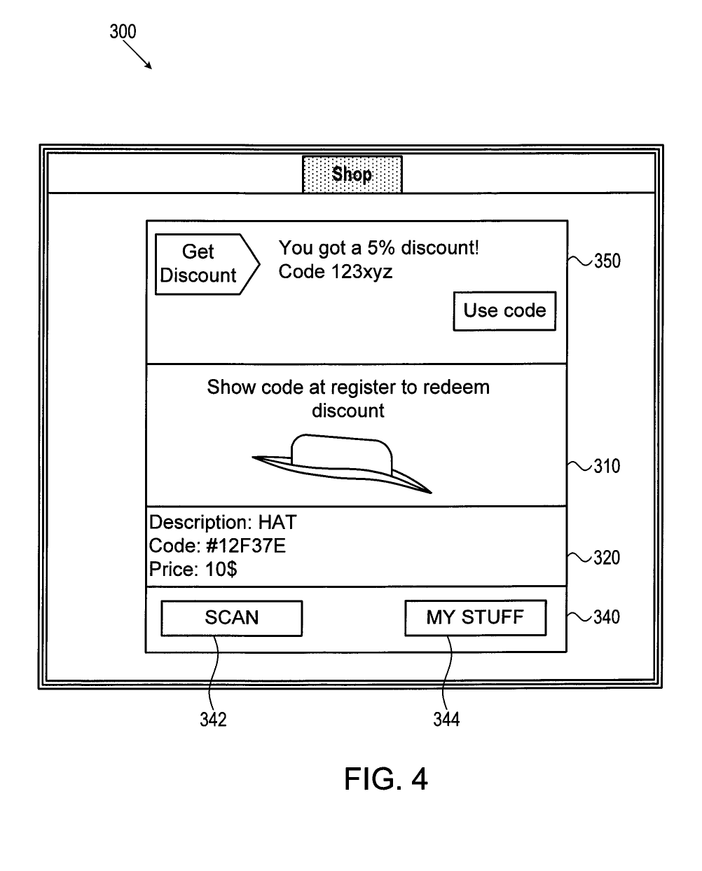

FIG. 4 is a schematic illustration of mobile device 140 with discount application 300 after receiving a discount message 350, according to an exemplary embodiment of the disclosure. In some embodiments of the disclosure, the discount message 350 and any other message or notification from server 160 or retailer workstation 170 to mobile device 140 may be in the form of an email, an SMS or as an internal application notification provided directly to discount application 300. Optionally, discount application 300 incorporates the message in the application and can then provide an alert so that customer 130 will be notified to review the message or notification.

FIG. 5 is a schematic illustration of mobile device 140 with discount application 300 showing the customer wish list 360, according to an exemplary embodiment of the disclosure. Optionally, every scan is initially recorded in wish list 360. If customer 130 requests a discount, the discount message 350 is recorded in wish list 360. Optionally, even if customer 130 does not request a discount the scanned items details are recorded as a line 370 in wish list 360. Optionally, an item 122 in the wish list 360 indicates that the customer has an interest in the item, either by immediately downloading a discount code and purchasing the item, or by initiating the discount process and purchase at a later date using the mobile device. Alternatively, the customer can wait for a price mark-down to purchase the item 122 at a lower price. In an exemplary embodiment of the disclosure, retailer workstation 170 receives notification of customers interested in a specific item 122. Optionally, the retailer may provide various notifications, for example notification of a price markdown, a special discount or a group sale to the customers 130 that placed the item 122 in their wish list. A customer that receives (280) such a notification from retailer workstation 170 can come to store 115 and perform the discount process described above by publicizing (250) the item in his/her social network account. Optionally, the customer may order the item online although additional shipping charges may be applied.

In some embodiments of the disclosure, the notification from retailer workstation 170 might automatically provide the discount without requiring additional publication. In an exemplary embodiment of the disclosure customer 130 may delete items from wish list 360 so that he/she will not receive notifications related to the item 122.

In some embodiments of the invention, upon receiving notification from a retailer customer 130 can respond by ordering the item so that it will be reserved for the customer at the store 115, for example for a limited time. Optionally, the customer 130 may collect the item 122 at a later date and then pay for the item. In some embodiments of the disclosure application 300 may enable customer 130 to pay for item 122 using mobile device 140. Optionally, the retailer may ship the item to customer 130 so that customer 130 does not need to visit/return to store 115 to purchase the item 122.

In some embodiments of the disclosure, friends or followers of the customer may respond to the customer's publication from their computing device and add the item 122 to their wish list 360 without physically seeing the item 122 and scanning the item code 123. Optionally, such customers are referred to as second tier customers and they may be allowed to perform the same processes with application 300 as the first tier customers that actually scanned the item 122. Optionally, second tier customers may order items from their wish list 360 publicize them in their social network and receive discounts like first tier customers. It should be noted that second tier customers may act from a general purpose desktop computer or any other type of computing device, since they do not need to visit the store with the computing device.

In some embodiments of the disclosure the retailer can benefit from having a list of costumers 130 interested in an item to acquire a price reduction, to trigger a group sale or to get rid of a specific item 122 at a discount, for example an out of season item or overstocked item.

In some embodiments of the disclosure, a customer is limited to a single discount per item or per store/retailer. Alternatively, the customer may be allowed a specific number of discounts, per day or other time period, per store, or per item.

In an exemplary embodiment of the disclosure, a retailer may have a general donation item code that can be offered to customers at the check out. Optionally, a customer purchasing over a minimum amount may be offered to scan the general donation code and the retailer will donate a specific sum or percent of the sale to a specific charitable cause or one selected by the customer. Optionally, in exchange the user will be required to publicize the donation in the social network as described above for receiving a discount. For example, the customer may publicize on his/her Facebook wall that he/she initiated a donation to the charitable cause by the retailer.

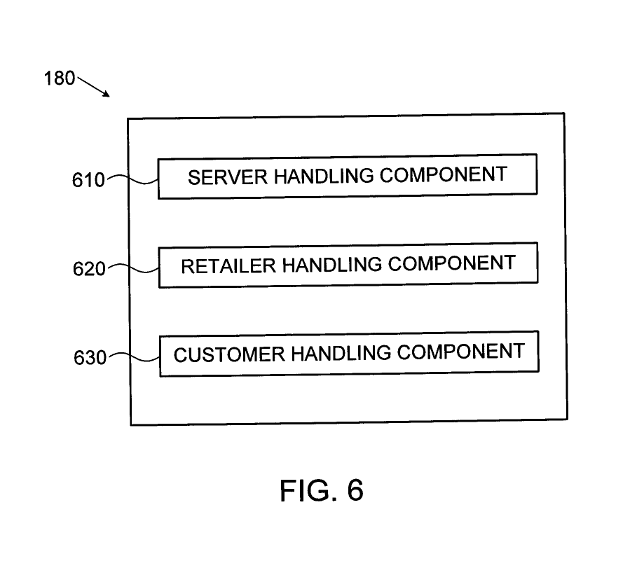

FIG. 6 is a schematic illustration of discount application 180, according to an exemplary embodiment of the disclosure. Discount application 180 is executed on server 160 and communicates with retailer workstations 170 and mobile devices 140. In an exemplary embodiment of the disclosure, discount application 180 includes three components:

1. a server handling component 610 that stores and extracts retailer information, customer information, item information and transaction information, and coordinates between the other components;

2. a retailer handling component 620 that interacts with retailers to allow them to upload information (e.g. item details, pictures, prices, possible discounts), update information and retrieve information (e.g. the number of customers interested in an item); and

3. a customer handling component 630 that interacts with mobile devices 140 providing for example item information, discount information, discount codes, and recording transactions performed by the mobile device.

In an exemplary embodiment of the disclosure, server handling component 610 may keep a database of registered customers, registered retailers, an item list for each retailer.

Registered customer information may include:

1. Name;

2. Email;

3. Mobile number;

4. Mailing address;

5. Login name and password;

6. Items in customer's wish list;

7. Items purchased;

8. Enrollment date;

And other related information.

In an exemplary embodiment of the disclosure, a customer's mobile device 140 may use imaging device 145 to scan item code 123. Optionally, the mobile device 140 may access server 160 using a standard web browser (e.g. iPhone Safari or Android Browser) or may download a dedicated application that serves as an agent for accessing server 160. Optionally, customer interaction details may be recorded on server 160 or may be recorded on the customer mobile device 140 or at both locations. In some embodiments of the disclosure server application 180 provides customer 140 with the item details, pictures, discounts and other related information. Optionally, server 160 keeps track of the items scanned by the customer and provides the information to the customer when queried by the mobile device 140.

In an exemplary embodiment of the disclosure, retailer information may include:

1. Retailer name;

2. Store address/GPS location;

3. Enrollment date;

4. Billing/contact details;

5. Item codes provided by the retailer;

6. Retailer logo;

And other related information.

Optionally, a retailer uses a dedicated application or a standard web browser (e.g. Explore, Chrome or Firefox) to access server 160. The retailer logs on to the server application 180 and then can add items, remove items or update details from the retailer's item list. Optionally, the retailer is provided with the ability to access details of customers that scanned the retailer's items, so that the retailer may offer price updates or other sale options to customers that added an item to their wish list 360. In some embodiments of the disclosure, the retailer can only provide notifications to customers through server application 180 and is not provided directly with customer details, to protect the customers 130 from misuse of the information.

In an exemplary embodiment of the disclosure, item information may include:

1. Name;

2. Category;

3. Sub-category;

4. Brand name;

5. Price;

6. Discount options;

7. Number of times scanned by customers;

8. Number of times discounts were requested for the item;

9. Number of customers with item currently on their wish list;

10. Pictures;

11. SKU (stock keeping unit);

12. Variations (e.g. sizes, colors);

13. Description;

Optionally, when a user is located at a retailer's store the user will scan item codes 123 and receive item details from discount application 180 on server 160.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

I/We claim:

1. A method of receiving a discount in exchange for social media advertising for items in a store, comprising:
finding an item of interest at a store by a customer with a mobile device that is configured to execute a discount application; wherein an item code is displayed on or near the item;
entering the item code into the mobile device;
communicating the item code to a server computer to retrieve information about the item;
retrieving the information about the item from the server, wherein the information includes one or more discount options that are provided responsive to publication of the item in a social network in which the customer participates;
storing the information about the item and the discount options in a list that is accessible by the mobile device.

2. A method according to claim 1, further comprising:
selecting a desired discount option;
publicizing the item in the social network in which the customer participates;
receiving a discount code from the server.

3. A method according to claim 2, further comprising:
revealing the discount code when checking out at the store to receive a discount for the item.

4. a method according to claim 3, further comprising:
offering customers at the checkout to generate a donation, where a specific sum or percent of the sale will be donated to a charitable cause by the retailer, responsive to publicizing the donation in the social network account of the customer;
entering a donation code to initiate the donation.

5. A method according to claim 2, further comprising:
ordering the item at any location or time based on the information in the list and providing the discount code.

6. A method according to claim 2, further comprising:
viewing the publication of the item in the social network in which the customer participates by a friend of the customer using a computing device; and
adding the item to a list at the friends computing device.

7. A method according to claim 5, further comprising:
ordering the item by the friend from the list at the friends computing device.

8. A method according to claim 1, further comprising:
notifying a store manager that one or more customers entered the item code of a specific item into their mobile device;
updating the server to notify the one or more customers of a notification related to the item.

9. A method according to claim 1, wherein entering the item code is performed by scanning the code with a digital camera of the device.

10. A method according to claim 9, wherein the item code is a quick response code.

11. A method according to claim 1, wherein the mobile device is a mobile telephone.

12. A method according to claim 11, wherein the mobile device is a smartphone.

13. A method according to claim 1, wherein the mobile device is a not a mobile telephone.

14. A method according to claim 1, wherein said list is stored at the server.

15. A method according to claim 1, wherein said list is stored on the mobile device.

16. A method according to claim 1, wherein different types of publication provide discount options with different size discounts.

17. A method according to claim 16, wherein a publication with a larger exposure receives a larger discount.

18. A method according to claim 1, wherein the size of the discount is a function of the size of the customer's social network.

19. A method according to claim 1, wherein the mobile device communicates with the server over a wireless Internet network.

20. A method according to claim 1, wherein the mobile device communicates with the server over a cellular wireless network.

21. A system for receiving discounts for an item in a store, comprising:
a server computer for executing a discount application having a server handling component, a retailer handling component and a customer handling component;
wherein the retailer component is configured to accept details of a retailer and details of items sold by the retailer at the store;
wherein the customer handling component is configured to communicate with a mobile device used by the customer at the store and receive from the mobile device an item code that is displayed on or near the item in the store;
wherein the server handling component is configured to provide the mobile device with information related to the item and one or more discount options that are provided responsive to publication of the item in a social network in which the customer participates.

22. A system according to claim 21, wherein the customer handling component is configured to accept the selection of a discount option by the mobile device and generates or verifies publication of the item or the retailer in a social network in which the customer participates; and
responsive to the verification, provide the mobile device with a discount code for the customer to receive a discount for the item when checking out at the store.

23. A system according to claim 21, wherein the retailer handling component is configured to notify a retailer that one or more customers entered the item code of a specific item and receive from the retailer notifications related to the specific item; and
transfer the notifications to one or more customers.

24. A system according to claim 21, wherein the details of the items sold in the store include a description of the item, an item code, and one or more discount options that are provided responsive to publication of the item or the retailer in a social network in which the customer participates.

25. A system according to claim 21, wherein different types of publications provide the customer with different size discounts.
